(19) United States
(12) Patent Application Publication
(10) Pub. No.: US 2005/0212947 A1
(43) Pub. Date: Sep. 29, 2005

(54) Image capture apparatus

(75) Inventors: Tsuneo Sato, Saitama (JP); Atsuhiko Ishihara, Saitama (JP); Hiroshi Yamasako, Saitama (JP); Youichi Sawachi, Saitama (JP); Takao Kiuchi, Saitama (JP); Naoya Iwata, Saitama (JP)

Correspondence Address: MCGINN & GIBB, PLLC, 8321 OLD COURTHOUSE ROAD, SUITE 200, VIENNA, VA, 22182-3817, US

(73) Assignee: Fuji Photo Film Co., Ltd., Minami-Ashigara-shi (JP)

(21) Appl. No.: 11/088,835

(22) Filed: Mar. 25, 2005

(30) Foreign Application Priority Data
Mar. 26, 2004 (JP) 2004-093633

(51) Int. Cl. H04N 5/225

(52) U.S. Cl. 348/340; 348/374

(57) ABSTRACT

A solid state imaging device is consisted of an image sensor chip having a light receiving portion, a frame-like spacer attached on the image sensor chip so as to surround the light receiving portion, and a transparent cover glass attached on the spacer so as to close the light receiving portion. An outer periphery of the spacer is projected from that of the solid state imaging device to form a projection. Along an inner periphery of a lens holding frame, a groove is formed. When the lens holding frame is attached to the solid state imaging device to cover it, the groove of the lens holding frame is engaged to the projection of the solid state imaging device.

### BACKGROUND OF THE INVENTION

1. Field of the Invention

The present invention relates to an image capture apparatus used in an electronic camera, a mobile phone and so on.

2. Description Related to the Prior Art

An image capture apparatus, for example a digital camera and a digital video camera, using a solid state imaging device (such as CCDs, CMOS type and the like) is in widespread use. Further, an electronic apparatus (a personal computer, a mobile phone, an electronic notepad or the like) is provided with the image capture apparatus, to have an image-taking function.

In packaging methods for the solid state imaging device, there is a ceramic packaging method. In this method, an image sensor chip on which light receiving portion is formed is mounted on a subsidiary substrate, then a ceramic frame is disposed on the subsidiary substrate so as to surround the image sensor chip, and then a transparent plate is disposed on the ceramic frame so as to seal the image sensor chip.

As another packaging method for the solid state imaging device, there is a wafer-level chip size packaging method which does not use the ceramic package. In the wafer-level chip size packaging, a spacer is disposed on a chip having a light receiving portion so as to surround the light receiving portion, and then a cover glass is disposed on the spacer so as to seal the light receiving portion.

The solid state imaging device is adhesively attached to an end of a cylindrical-shaped lens holding frame or lens barrel for holding a taking lens. In addition, as a method for holding the solid state imaging device, Japanese Patent Laid-Open Publications No.08-307744 recites that a solid state imaging device is held by sandwiching it between two lens holding frames. As another embodiment, Japanese Patent Laid-Open Publications No.2002-185826 recites that a subsidiary substrate, on which an image sensor chip is attached, is attached to a main substrate, and then a lens holding frame is attached on the main substrate so as to cover the light receiving portion.

However, when it is designed to adhere the solid state imaging device to the lens holding frame, it is difficult to precisely position these devices or members. Further, to use the pair of lens holding frames as described in Japanese Patent Laid-Open Publications No.08-307744, complicated assembling process is needed. In addition, in Japanese Patent Laid-Open Publications No.2002-185826, it is difficult to precisely determine relative positions of the solid state imaging device and the taking lens, because the solid state imaging device is mounted on the subsidiary substrate, and both the subsidiary substrate and the lens holding frame are attached on the main substrate. In fact, the relative positions of the solid state imaging device and the taking lens is determined, depending on several elements, namely relative position of the solid state imaging device to the subsidiary substrate, that of the subsidiary substrate to the main substrate, and that of the main substrate to the lens holding frame. It is difficult to precisely set all these members at their correct positions.

### SUMMARY OF THE INVENTION

A main object of the present invention is to provide an image capture apparatus being assembled easily with precision.

Another object of the present invention is to provide an image capture apparatus which prevents a solid state imaging device and a taking lens from being broken and misaligned from their relative positions when being exposed to an external force such as an impact shock.

In order to achieve the above objects and the other objects, in the present application, a solid state imaging device is fitted in a lens holding frame through the engagement of a projection and a groove. In a preferable embodiment of the present invention, the solid state imaging device has a structure where a frame-like spacer is disposed on a semiconductor substrate having a light receiving portion so as to surround the light receiving portion and then a transparent plate is disposed on the spacer so as to seal the light receiving portion. A projection is provided in one of an inner periphery of the lens holding frame which holds a taking lens and an outer periphery of the solid state imaging device, and a groove for fitting on the projection is provided in the other.

Since the semiconductor substrate, the spacer and the transparent plate come into a sandwich structure, the peripheral edge of the spacer which positions in the middle can become the projection when the spacer is formed larger than the semiconductor substrate and the transparent plate such that the outer periphery of the spacer is projected from that of the semiconductor substrate and the transparent plate. In contrary way, the groove can be formed such that the spacer is formed smaller than the semiconductor substrate and the transparent plate. Further, the projection or the groove may be formed in the outer periphery of the semiconductor substrate. In addition, the projection or the groove may be formed in the outer periphery of the transparent plate.

It is preferable to provide a protector which covers an outer periphery of the lens holding frame, and to dispose a shock absorber between the protector and the lens holding frame.

According to the image capture apparatus of the present invention, because the projection is formed in one of the inner periphery of the lens holding frame or the outer periphery of the solid state imaging device, and a groove for fitting on the projection is formed in the other, the image capture apparatus is easily assembled by simply fitting the solid state imaging device into the lens holding frame. Also, positioning the each device or member is not required in assembling. Further, a click feeling is obtained when the projection fits in the groove, a manufacturer can easily confirm the completion of the fit. In addition, because the lens holding frame is directly attached to the solid state imaging device, there is few factor which influences the relative positions of the solid state imaging device and the taking lens. Therefore, the image capture apparatus is assembled with higher accuracy.

In case that the projection is formed such that the outer circumference of the spacer is formed larger than that of the semiconductor substrate and the transparent plate, manufacturing cost can be held down. In contrary case that the groove may be formed such that the outer circumference of the spacer is formed smaller than that of the semiconductor substrate and the transparent plate, the manufacturing cost can be also held down.

Since the protector covers the outer periphery of the lens holding frame, and the shock absorber is disposed between the protector and the lens holding frame, the solid state imaging device can avoid being broken and misaligned when exposed to the external force such as the impact shock.

### BRIEF DESCRIPTION OF THE DRAWINGS

The above objects and advantages of the present invention will become easily understood by one of ordinary skill in the art when the following detailed description would be read in connection with the accompanying drawings.

FIG. 1 is a perspective view of a front side of a mobile phone with a camera;

FIG. 2 is a perspective view of a rear side of the mobile phone with a camera;

FIG. 3 is an exploded perspective view of an image capture apparatus;

FIG. 4 is an exploded perspective view of the image capture apparatus;

FIG. 5 is an exploded sectional view of the image capture apparatus;

FIG. 6 is an exploded sectional view of an image capture apparatus which has a groove formed around a spacer;

FIG. 7 is a sectional view of an image capture apparatus which has a protector; and

FIG. 8 is a sectional view of an image capture apparatus in which a circuit board and a solid state imaging device are connected by a printed wiring board.

### PREFERRED EMBODIMENTS OF THE INVENTION

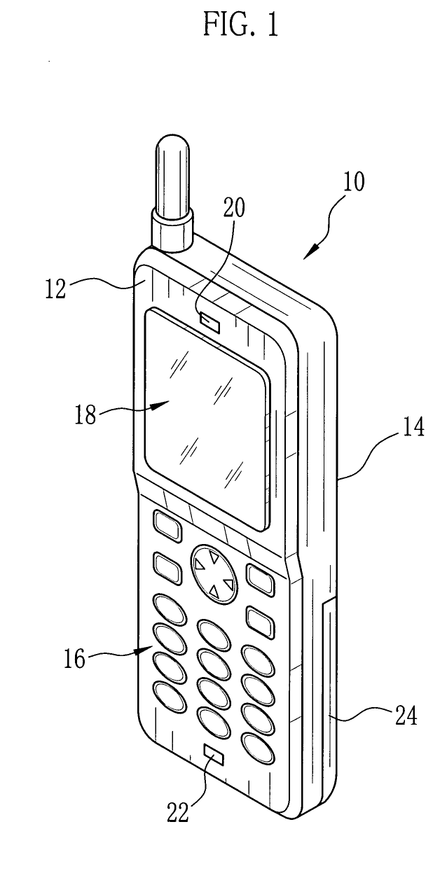

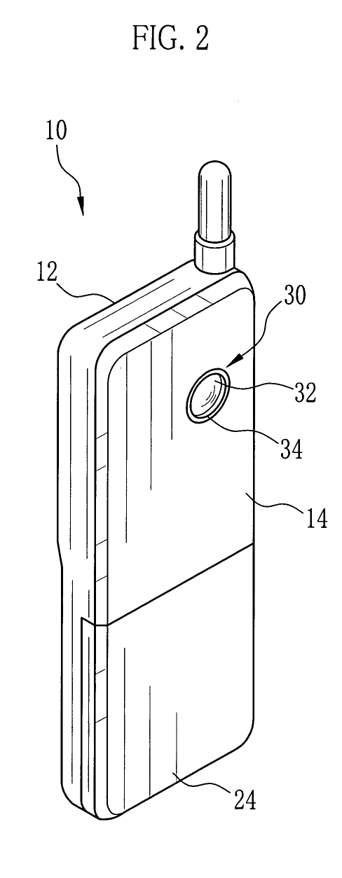

In FIG. 1 and FIG. 2, a mobile phone with a camera 10 has an outer package constituted of a front cover 12 and a rear cover 12. A circuit board on which electronic components are provided is contained within these covers. In a front face of the mobile phone 10, there are an operation section 16, liquid-crystal display panel 18, an ear receiver 20 and a microphone 22, while the ear receiver 20 and the microphone 22 are used for conversation. In the mobile phone 10, a battery 24 for supplying electric power is attached to a rear face thereof in a detachable manner, and an image capture apparatus 30 having a taking lens 32 and a lens holding frame 34 is disposed.

The mobile phone with a camera 10 operates in a telephone mode for having a conversation through the ear receiver 20 and the microphone 22, and in a camera mode for storing images through the taking lens 32 in an internal memory (not shown). These modes can be switched by operating the operation section 16. In addition, by operating the operation section 16, phone numbers can be inputted in the telephone mode, and a shutter can be released in the camera mode. The liquid-crystal display panel 18 displays the phone numbers stored in the internal memory and various information of the mobile phone. And in the camera mode, the liquid-crystal display panel 18 displays through images for framing.

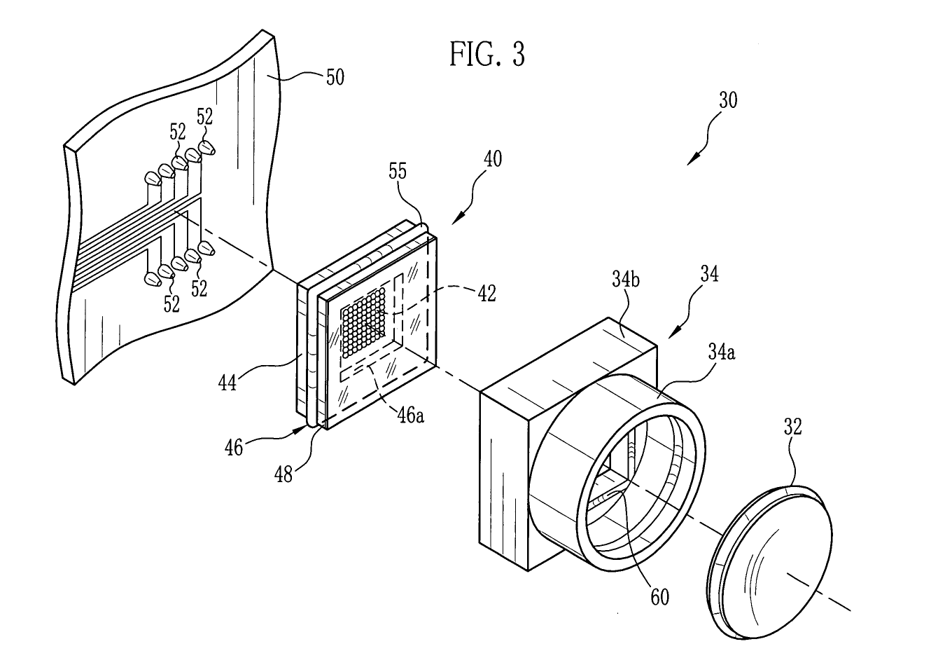

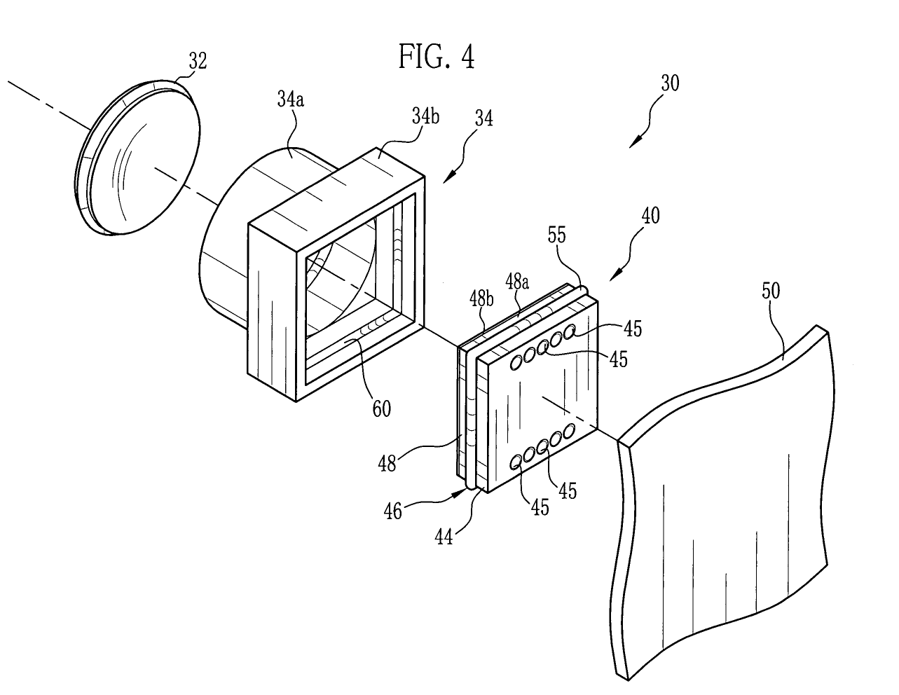

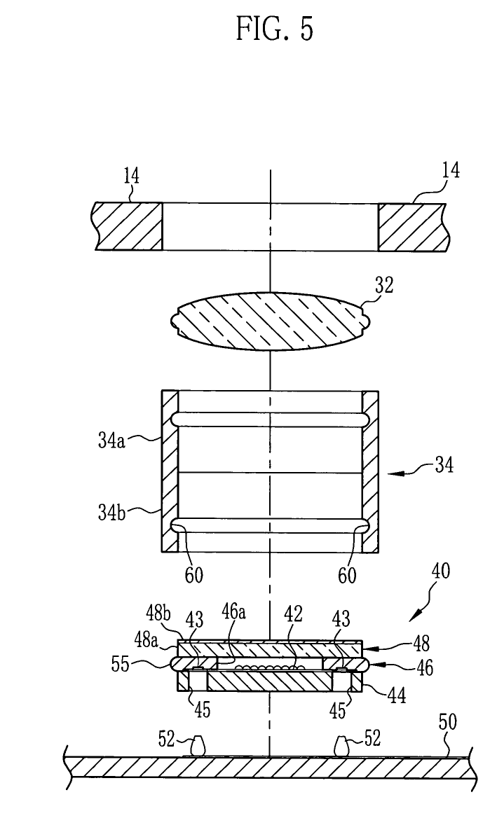

As shown in FIG. 3 to FIG. 5, the image capture apparatus 30 is constituted of the taking lens 32, the lens holding frame 34 and a solid state imaging device 40. The taking lens 32 is held by the lens holding frame 34. The lens holding frame 34 is constituted of a cylindrical-shaped lens holding portion 34a and a box-shaped attachment portion 34b. A groove is formed around an inner peripheral surface of the lens holding portion 34a, so as to fit on a projection which is formed around an outer periphery of the taking lens 32. Accordingly, the taking lens 32 can fit to be held in the lens holding portion 34a.

Inside the attachment portion 34b, the solid state imaging device 40 of wafer level chip size package is disposed. The solid state imaging device 40 is constructed of a rectangular-shaped image sensor chip 44 on which a light receiving portion 42 is provided, a frame-like spacer 46 which is attached onto the image sensor chip 44 so as to surround the light receiving portion 42, and a transparent cover glass 48 which is disposed above the spacer 46 so as to seal the light receiving portion 42. The solid state imaging device 40 is fixedly attached to the circuit board 50.

The image sensor chip 44 is obtained by forming a plurality of the light receiving portions 42 and contact terminals 43 on a wafer, and then dicing the wafer into the chips each of which has one light receiving portion 42. The light receiving portions 42 is for example a CCD. On the CCD, a color filter and a micro lens are superimposed. The contact terminals 43 are obtained by, for example, printing a conductive material on the image sensor chip 44. The contact terminals 43 and the light receiving portion 42 are connected by a wiring layer formed on the image sensor chip 44.

The image sensor chip 44 has through-holes 45 which appear on a rear face of the contact terminals 43. On the circuit board 50, bumps 52 are formed at positions corresponding to the positions of the through-holes 45. The bumps 52 have an approximately equal height to the depth of the through-holes 45, and are connected to the wiring of the circuit board 50. When the solid state imaging device 40 is attached to the circuit board 50, each bump 52 is inserted into the through-hole 45 so as to contact to the contact terminal 43. Accordingly, the solid state imaging device 40 can be electrically connected to the circuit board 50.

The cover glass 48 is constructed of a low-α-ray glass 48a and an IR-cut filter 48b which is joined on the low-α-ray glass 48a. The low-α-ray glass 48a emits only a small intensity of α-ray is generated, so as to prevent the pixels of the light receiving portion 42 from being destroyed by the α-ray. The IR-cut filter 48b cuts the infrared ray in the predetermined wavelength range so as to prevent a ghost and fogging. A low-path filter for preventing the occurrence of false color is superimposed on the IR-cut filter 48b. Since the low-α-ray glass 48a and the IR-cut filter 48b are integrated, the attachment space becomes smaller and the attachment operations become easier.

The spacer 46 is a square frame having an opening 46a in the center and is adhered onto the upper face of the image sensor chip 44 with an adhesive, such as epoxy resin, so as to surround the light receiving portion 42. The spacer 46 is formed of an inorganic material (for example, silicon, stainless or the like) whose coefficient of thermal expansion is close to that of the image sensor chip 44. The spacer 46 is disposed to form a space between the light receiving portion 42 and the cover glass 48. Since the space prevents the interference of the cover glass 48 to the micro lens of the light receiving portion 42, the functions of the micro lens don't become worse.

The spacer 46 has a larger outer periphery than that of the image sensor chip 44 and the cover glass 48, which have approximately the same shape. Therefore, the outer periphery of the spacer 46 is projected from an outer periphery of the solid state imaging device 40, to form a projection 55.

The attachment portion 34b of the lens holding frame 34 has an inner circumference slightly larger than the outer circumferences of the image sensor chip 44 and the cover glass 48. And on the inner peripheral surface of the attachment portion 34b, the groove 60 is formed. The lens holding frame 34 is attached to the solid state imaging device 40 so as to cover it. The groove 60 of the attachment portion 34b is then engaged to the projection 55 of the solid state imaging device 40, which fixes the lens holding frame 34.

Since the lens holding frame is directly attached to the solid state imaging device, the relative positions of the solid state imaging devise and the taking lens are determined regardless of how precise the circuit board is made to be. Therefore, the determination of the relative positions can be precisely made. Further, the image sensor chip, which is formed by dicing the wafer, has high precision. Therefore, the relative positions of the solid state imaging devise and the taking lens can be easily determined with precision.

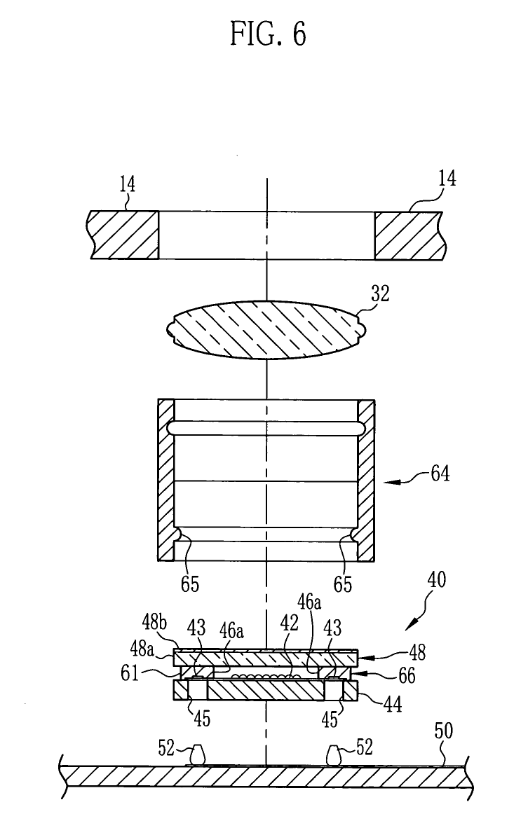

In the above embodiment, the projection is provided in the solid state imaging device, and the groove is provided in the lens holding frame. However, the groove may be provided in the solid state imaging device, and the projection may be provided in the lens holding frame. In this case, as shown in FIG. 6, a groove 61 may be formed by using a spacer 66 smaller than the cover glass 48 and the image sensor chip 44, and a projection 65 for fitting in the groove 61 may be formed in a lens holding frame 64. In addition, the projection and the groove may be formed in the outer periphery of the image sensor chip or the cover glass, instead of the spacer. Note that in FIG. 6 to FIG. 8, same numerals are applied to the same parts as the above embodiment.

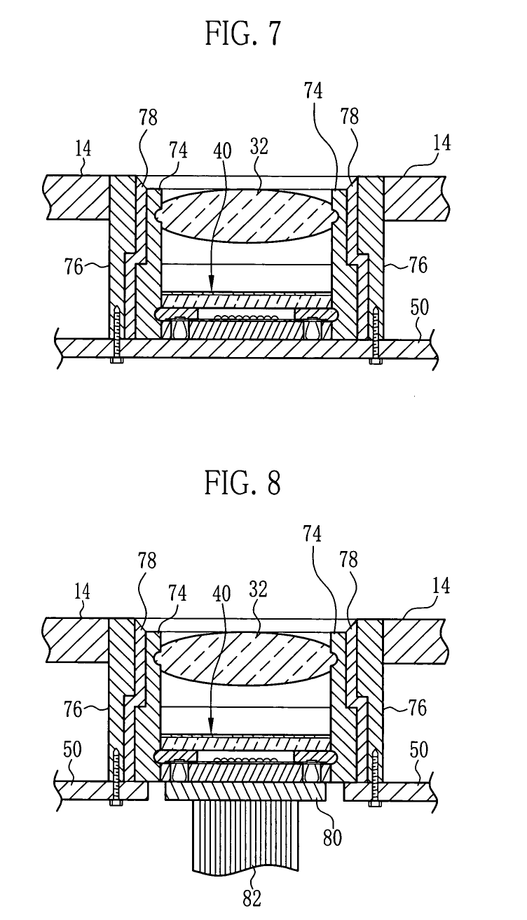

There may be a case that the solid state imaging device and the taking lens get impact when the mobile phone is dropped down. By considering this problem, a lens holding frame 74 may be protected for example by a protector 76, as shown in FIG. 7. The protector 76 covers an outer periphery of the lens holding frame 74, and is screwed to the circuit board 50. In addition, a shock absorber 78 formed of rubbers, sponges or the like is disposed between the protector 76 and the lens holding frame 74. Since the shock absorber 78 reduces the impact, the solid state imaging device 40 and the taking lens 32 can avoid being broken, and the relative positions of the solid state imaging device 40 and the taking lens 32 can be hardly misaligned.

In addition, the solid state imaging device may be separated from the circuit board. For example, the solid state imaging device 80 is attached to a subsidiary substrate 80, and the subsidiary substrate 80 is connected to the circuit board 50 through a flexible printed wiring board 82, as shown in FIG. 8. Note that a protector 76 may be attached to the rear cover 14 of the mobile phone 10, instead of being screwed to the circuit board 50.

The present invention may be applied to a digital camera, a digital video camera, and a PC camera and so on, in addition to the mobile phone with a camera.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

1. An image capture apparatus including a solid state imaging device which converts an image focused by a taking lens into electronic signals, comprising:
a lens holding frame for holding a taking lens;
a projection provided in one of an inner periphery of said lens holding frame and an outer periphery of said solid state imaging device; and
a groove provided in the other of said inner periphery of said lens holding frame and said outer periphery of said solid state imaging device, for fitting on said projection.

2. An image capture apparatus as described in claim 1, said solid state imaging device comprising:
a semiconductor substrate having a light receiving portion for converting said image into said electronic signals;
a spacer attached on said semiconductor substrate for surrounding said light receiving portion; and
a transparent plate attached on said spacer.

3. An image capture apparatus as described in claim 2, wherein said projection is formed such that a contour of said spacer positioned in the center is larger than that of said semiconductor substrate and said transparent plate.

4. An image capture apparatus as described in claim 2, wherein said groove is formed such that a contour of said spacer positioned in the center is formed smaller than that of said semiconductor substrate and said transparent plate.

5. An image capture apparatus as described in claim 2, wherein said projection or said groove is formed in an outer periphery of said semiconductor substrate.

6. An image capture apparatus as described in claim 2, wherein said projection or said groove is formed in an outer periphery of said transparent plate.

7. An image capture apparatus as described in claim 1, further comprising:
a circuit board on which said solid state imaging device is attached;
a through-hole provided in said semiconductor substrate; and
a bump provided on said circuit board, to be inserted into said through-hole, said semiconductor substrate and said circuit board being electrically connected through said bump and said through-hole.

8. An image capture apparatus as described in claim 7, further comprising:
a protector covering an outer periphery of said lens holding frame; and
a shock absorber disposed between an inner periphery of said protector and said outer periphery of said lens holding frame.

9. An image capture apparatus as described in claim 8, wherein said protector is attached to said circuit board.

10. An image capture apparatus as described in claim 8, wherein said circuit board is a subsidiary circuit board, and said image capture apparatus further comprising:
a main circuit board to which said protector is attached; and
a flexible printed wiring board for connecting said main circuit board and said subsidiary circuit board.
